(19) United States
(12) Patent Application Publication
(10) Pub. No.: US 2023/0248030 A1
(43) Pub. Date: Aug. 10, 2023

(54) LIQUID FERMENTED SEASONING AND ITS MANUFACTURING METHOD

(71) Applicant: Hanamaruki Foods Inc., Ina-Shi (JP)

(72) Inventors: Shuntaro YANO, Tokyo (JP); Kazuki KAMIKURA, Tokyo (JP)

(73) Assignee: Hanamaruki Foods Inc., Ina-Shi (JP)

(21) Appl. No.: 17/996,677

(22) PCT Filed: Apr. 28, 2021
(86) PCT No.: PCT/JP2021/016949

§ 371 Date: Oct. 20, 2022

(30) Foreign Application Priority Data
May 1, 2020 (JP) 2020-081278

(51) Int. Cl. A23L 7/104; A23L 27/24

(52) U.S. Cl. CPC A23L 7/104; A23L 27/24

(57) ABSTRACT

[Problem] To suppress occurrence of cloudiness in the rice-derived liquid fermented seasoning.

[Solution] A rice-derived liquid fermented seasoning wherein in a chromatogram curve obtained by high-performance liquid chromatography (HPLC) measurement using a gel filtration carrier, the ratio of the area of peak (A) detected at a retention time of around 17.5 minutes to the total peak area (area of peak (A) / total peak area × 100) in the chromatogram curve is 2 or more.

### BACKGROUND OF THE INVENTION

### Technical Field

The present disclosure relates to a novel liquid seasoning and a method for producing the novel liquid seasoning.

### Technical Background

Malted rice (kome-koji) is used as a traditional raw material that produces complicated, preferable flavor for the production of alcoholic drinks, such as sake, shochu, and sweet sake (mirin), and for the production of brewing seasonings. The sweet sake is known as a seasoning whose main raw material is malted rice, and the sweet sake is used as seasoning that adds strong sweetness.

Recently, salted rice malt (shio-koji) is attracting attention. The salted rice malt is a seasoning in which malted rice, salt and water are mixed, fermented, and matured. The taste of the salted rice malt is complex taste in which umami, sweetness, and saltiness are mixed with good balance. The salted rice malt is referred to as all-purpose seasoning. In addition, the salted rice malt contains enzymes. It is said that using the salted rice malt for pickling foods, such as vegetable, meat and fish, brings out the taste of the foods. For example, Japanese Patent No. 5039964 (patent document 1) discloses powder-type salted rice malt that is obtained by drying and crushing salted rice malt.

Also, Japanese Patent Laid-open Publication No. 2004-267057 (patent document 2) discloses a seasoning having a meat-quality improving effect, characterized in that moromi mixed with cereal koji prepared by using raw materials whose total nitrogen is adjusted to 3.0 mass% or more and salt water is matured for 0.5 to 2.0 months at a low temperature, followed by solid-liquid separation. However, this document only refers to so called “soy sauce koji” that is koji made from soybeans and wheat, and the malted rice is excluded from the cereal koji. Further, the taste of this seasoning mainly comes from umami and saltiness, and is thought to have less sweetness.

Furthermore, in Japanese Patent No. 6068068, it is disclosed by the present disclosers that when a preparation liquid in which malted rice, salt, and water are mixed is subjected to fermentation and maturation at a low temperature and then subjected to solid-liquid separation, a novel liquid seasoning is obtained which retains the function of the salted rice malt and tastes of umami, sweetness, and saltiness are well-balanced.

### PRIOR ART DOCUMENTS

### Patent Documents

Patent document 1: JP 5039964 B
Patent document 2: JP 2004-267057 A
Patent document 3: JP 6068068 B

### SUMMARY OF INVENTION

However, it was found that when the rice-derived liquid fermented seasoning comprising rice or malted rice as raw material left for a long period or when it is used with vinegar may become cloudy.

Under these technical circumstances, the present disclosers have recently found that the occurrence of cloudiness can be suppressed in rice-derived liquid fermented seasonings by controlling the ratio of a specific molecular weight peak to the total peak area. The present disclosure is based on these findings.

Thus, the present disclosure is to provide a technical mean to suppress occurrence of cloudiness in the rice-derived liquid fermented seasoning.

According to one embodiment of the present disclosure, (1) to (15) are provided.

A rice-derived liquid fermented seasoning wherein in a chromatogram curve obtained by high-performance liquid chromatography (HPLC) measurement using a gel filtration carrier under the following analysis conditions, the ratio of the area of peak (A) detected at a retention time of around 17.5 minutes to the total peak area (area of peak (A)/total peak area x 100) in the chromatogram curve is 2 or more.

### HPLC Analysis Condition

Mobile phase: 0.1 M phosphate buffer (pH 6.8)
Flow rate: 0.35 mL/min
Gel filtration column: Silica packed column (column length 300 mm x inner diameter 4.6 mm)
Detection wavelength: 280 nm

The liquid fermented seasoning according to (1), wherein the chromatogram curve is a chromatogram curve in the range of molecular weight 0 to 670,000.

The liquid fermented seasoning according to (1) or (2), wherein the molecular weight of the peak (A) is in the range of 0 to 200.

The liquid fermented seasoning according to any of (1) to (3), wherein the ratio of the area of peak (C) detected at a retention time around 14.3 minutes to the total peak area (area of peak (C) / total peak area x 100) is 7.5 or more.

The liquid fermented seasoning according to (4), wherein the peak (C) molecular weight is in the range of 750 to 1.300.

The liquid fermented seasoning according to any of (1) to (5), wherein the ratio of the area of peak (A) to the area of peak (C) (area of peak (A)/area of peak (C)) is 0.24 or more.

The liquid fermented seasoning according to any of (1) to (6), having protease activity.

The liquid fermented seasoning according to any of (1) to (7), wherein the protease activity at pH 6.0 is 5 units/g or more.

The liquid fermented seasoning according to any of (1) to (8), wherein the salt content is 2 to 20 mass%.

The liquid fermented seasoning according to any of (1) to (9), wherein the water content is 30 to 70 mass%.

The liquid fermented seasoning according to any of (1) to (10), wherein the content of direct sugar is 10 mass% or more.

The liquid fermented seasoning according to any of (1) to (11), wherein the fermented raw material of the liquid fermented seasoning includes at least one ingredient selected from the group consisting of rice, malted rice and salted rice malt.

A food or drink prepared by adding the liquid fermented seasoning according to any of (1) to (12).

A method for producing a liquid fermented seasoning according to any one of (1) to (13), comprising:
obtaining a fermented and matured product by fermenting and maturing a preparation liquid in which rice malt, salt, water, and fermenting microorganisms are mixed;
performing solid-liquid separation of the fermented and matured product.

The method for producing liquid fermented seasonings according to (14), wherein the fermenting microorganism is at least one selected from the group consisting of yeast, koji mold, and lactic acid bacteria.

According to the present disclosure, it is possible to suppress occurrence of cloudiness in the rice-derived liquid fermented seasoning. Since cloudiness is unsightly and gives consumers a bad impression, in liquid brewed product, it is generally to denature and agglutinate the proteins that cause cloudiness in advance and remove them by orisage. However, according to the present disclosure, occurrence of cloudiness can be efficiently suppressed in the rice-derived liquid fermented seasoning without a removal process such as orisage. In addition, the present disclosure can be advantageously used to provide aesthetics and a sense of security to general consumers. Also, according to the present disclosure, the odor derived from fermentation strains can be suppressed in the liquid fermented seasonings and can be used to the advantage of consumers who have been averse to such odors.

### BRIEF EXPLANATION OF THE DRAWINGS

FIG. 1 illustrates an example of a production flow of the liquid fermented seasoning in the present disclosure.

FIG. 2 is a photo showing the result of cloudiness test in example 1 (3).

FIG. 3 is a chart of test block 1 and comparison block 1 obtained by HPLC analysis in molecular weight distribution measurement of liquid fermented seasoning.

### DETAILED DESCRIPTION OF THE INVENTION

### Liquid Fermented Seasoning

According to an embodiment of the present disclosure, the liquid fermented seasoning, wherein in a chromatogram curve obtained by high-performance liquid chromatography (HPLC) measurement using a gel filtration carrier under the following analysis conditions, the ratio of the area of peak (A) detected at a retention time of around 17.5 minutes to the total peak area (area of peak (A)/total peak area × 100) in the chromatogram curve is 2 or more, is provided.

### HPLC Analysis Condition

Mobile phase: 0.1 M phosphate buffer (pH 6.8)
Flow rate: 0.35 mL/min
Gel filtration column: Silica packed column (column length 300 mm x inner diameter 4.6 mm)
Detection wavelength: 280 nm

It is surprising that in rice-derived liquid fermented seasonings, a higher ratio of peak (A) detected at a retention time around 17.5 min can significantly suppress the occurrence of cloudiness in rice-derived liquid fermented seasonings. In addition, a well-balanced and good flavor or smell can be achieved in the rice-derived liquid fermented seasonings compared to liquid seasonings in which peak (A) is not within the above range.

Further details of the present disclosure are described below. The chromatogram curve obtained by the HPLC measurement is preferably a chromatogram curve within a retention time of 0 to 30 minutes, more preferably 0 to 25 minutes, further more preferably 0 to 20 minutes.

In addition, according to a preferable embodiment, the chromatogram curve is preferably a chromatogram curve with molecular weight is 0~670,000, more preferably 0~300,000, further preferably 0-100,000.

The retention time of peak (A) is generally around 17.5 minutes, preferably is in a range of 16.5 to 18.5 minutes, more preferably is in a range of 17 to 18 minutes.

The molecular weight of peak (A) is preferably in a range of 0 to 200, more preferably 5 to 195, further preferably 10 to 190.

The ratio of the area of peak (A) to the total peak area (area of peak (A)/total peak area × 100) is generally 2.0 or more, more preferably 2.5 or more, further preferably 3.0 or more.

The ratio of the area of peak (A) to the total peak area (area of peak (A)/total peak area × 100) is not particularly limited, but is preferably 30 or less, more preferably 25 or less, and further preferably 20 or less.

According to a preferable embodiment of the present disclosure, it is preferably that the liquid fermented seasoning has a peak (C) detected at a retention time around 14.3 minutes. The retention time is generally around 14.3 minutes, preferably in a range of 13.3 to 15.3 minutes, further preferably in a range of 13.8 to 14.8 minutes.

It is preferably that the ratio of the area of peak (C) in a chromatogram curve obtained by high-performance liquid chromatography (HPLC) measurement is large from the viewpoint of preventing cloudiness. According to an embodiment of the present disclosure, the ratio of the area of peak (C) detected at a retention time around 14.3 minutes (area of peak (C)/total peak area x 100) is generally 7.5 or more, preferably 9.0 or more, further preferably 10.0 or more.

The ratio of the area of peak (C) detected at a retention time around 14.3 minutes to the total peak area (area of peak (C)/total peak area × 100) is not particularly limited, but preferably 35 or less, more preferably 30 or less, and further preferably 25 or less.

The molecular weight of peak (C) is preferably in a range of 750 to 1300, more preferably 755 to 1295, further preferably 760 to 1290.

The ratio of the area of peak (A) to the area of peak (C) (area of peak (A)/area of peak (C)) is preferably 0.24 or more, more preferably in a range of 0.24 to 2, further preferably in a range of 0.24 to 1.

For HPLC measurement that using a gel filtration carrier (gel filtration matrix), silica may preferably be used as a gel filtration carrier. As a preferably example, the column for gel filtration with gel filtration carrier that has a particle size of 2 to 10 µm, a pore size of 100 to 160 angstroms, use pH 2.5 to 7.5, a maximum back pressure (psi) of 1200 to 1800, and a standard back pressure of 700 to 900 can be used. Each of the more specific parameters can be determined by the same criteria to BioSep-. SEC-s2000 (column length 300 mm × 4.6 mm i.d.) (Shimadzu Co., Ltd., etc.) which is used in the example described below.

The liquid fermented seasoning is preferably to be transparent from the viewpoint of providing aesthetics and a sense of security to general consumers. Here, “transparent” or not can be determined by the method described in example 1.

In the liquid fermented seasonings, it is preferable that the main liquid component is water from the viewpoint of utilizing the flavor derived from the raw materials. The content of water in liquid fermented seasonings is usually between 30 to 70% by mass, preferably 35 to 68% by mass, and more preferably 40 to 66% by mass.

It is preferable to prepare the liquid fermented seasoning in such a way that the enzyme derived from the strain used for fermentation and maturation is not inactivated (deactivated) from the viewpoint of utilizing the good flavor derived from the raw materials. Therefore, the liquid fermented seasoning is a liquid fermented seasoning with enzyme activity, preferably with protease activity. According to a preferable embodiment of the present disclosure, the protease activity of the liquid fermented seasoning at pH 6.0 is generally 5 units/g or more, preferably 10 units/g or more, and more preferably 15 units/g or more. Also, the protease activity is 100 units/g or less, preferably 90 units/g or less, and more preferably 80 units/g or less. The protease activity can be measured by Kageyama modification of phenol reagent method of Folin-Ciocalteu (Hakkokogaku Zasshi 33 (1) 28-32 (1995)).

The liquid fermented seasoning preferably contain salt from the viewpoint of achieving a well-balanced flavor. The content of slat is generally 2 to 20% by mass, preferably 3 to 18% by mass, more preferably 4 to 16% by mass. The concentration of slat can be measured by a known potential-difference titration device.

The liquid fermented seasoning preferably contains direct sugar from the viewpoint of achieving a well-balanced flavor. The content of direct sugar is generally 10% by mass or more, preferably 12% by mass or more, more preferably 15% by mass or more. And the upper limit of content of direct sugar is preferably 25% by mass or less, more preferably 20% by mass or less, further preferably 17% by mass or less. The concentration of direct sugar can be measured by Somogyi modification method.

As stated below, sterilization may be performed by adding alcohol into the liquid fermented seasoning. The content of alcohol in the liquid fermented seasoning may be preferably 1 to 10% by mass, more preferably 2 to 9% by mass, further preferably 3 to 8% by mass from the viewpoint of sterilizing effectively. The content of alcohol can be measured by gas chromatography. The liquid fermented seasoning may be prepared to be substantially free of ethanol. Such embodiments are including in the present disclosure.

pH is not particularly limited, for example it may be 4.0 to 6.0. pH is generally preferable to be 4.2 to 5.8. The measurement of pH can be performed by a commercially available pH meter.

The liquid fermented seasoning is rice-derived ferment. The raw material of fermentation included rice or its fermented processed product (malted rice and slat malt rice etc.).

According to an embodiment of the present disclosure, the liquid fermented seasoning is obtained by performing solid-liquid separation of preparation liquid mixed with rice malt, salt, water, and fermenting microorganisms after obtaining fermenting and maturing. In other words, method for producing the liquid fermented seasoning of the present disclosure contains performing solid-liquid separation of preparation liquid after fermenting and maturing a preparation liquid which is mixed by rice malt, salt, water, and fermenting microorganisms. In the present disclosure, ratio of area of peak (A) to peak (C) that determined by HPLC can be properly adjusted by properly adjust the proportion of raw material and condition of fermentation.

The malted rice used in the present disclosure may be prepared in accordance with a usual koji production method for producing malted rice. Specifically, the malted rice is obtained by spraying koji-mold (also referred to as seed malt) on steamed rice prepared by steaming rice, and then breeding the koji-mold under the condition optimal to the koji-mold. For breeding the koji-mold, an automatic fermentation machine (for example, HK-60, produced by Yaegaki Food & System, Inc.) may be used to perform cultivation for 2 to 4 days at 25° C. to 40° C. The malted rice used in the present disclosure may be a commercial product.

Rice, such as nonglutinous rice, glutinous rice and brewer’s rice, preferably polished rice (white rice), may be washed as necessary, soaked in water and drained as necessary.

The koji-mold is not limited in particular insofar as it is used for a normal production of koji. A preferable example is genus aspergillus (Asperuqillus), such as Aspergillus oryzae and Asperuqillus sojae. The koji-mold used in the present invention may be a commercial product sold as seed malt or may be a cultured mold. In addition, the koji-mold may be granular or powdery. The koji-mold used in the present invention preferably has high saccharification power or high productibility of protease. Specifically, the koji-mold used in the present invention may be koji-mold used for miso, koji-mold used for malted rice, or koji-mold used for soy sauce. More preferably, it is the koji-mold used for malted rice or the koji-mold used for miso. It is further preferably the koji-mold used for miso. One kind of koji-mold among these koji-molds may be used singly, or two or more kinds of koji-molds may be used in combination.

The fermenting microorganisms is not particularly limited if it can metabolize component of moromi during brewing process such as yeast (halotolerant yeast (Zygosaccharomyces rouxii) etc.), koji mold, and lactic acid bacteria.

The preparation liquid of the present disclosure is obtained by mixing malted rice, salt, water and fermenting microorganisms. These may be simultaneously put in and mixed or may be successively put in and mixed.

The malted rice is mixed desirably to have 30 to 70% by mass relative to the preparation liquid, preferably 35 to 60% by mass, more preferably 40 to 55% by mass, and further preferably 45 to 50% by mass.

The salt is mixed to desirably have 8 to 20% by mass relative to the preparation liquid, preferably 10 to 16% by mass, more preferably 12 to 15% by mass, and further preferably 13 to 14% by mass. This salt can inhibit or reduce growth of microorganisms in the preparation liquid.

The water is mixed to desirably have 30 to 70% by mass relative to the preparation liquid, preferably 30 to 60% by mass, more preferably 35 to 60% by mass, and further preferably 40 to 55% by mass.

The fermenting microorganisms is mixed to desirably have 0.001 to 0.1% by mass relative to the preparation liquid, preferably 0.005 to 0.08% by mass, more preferably 0.01 to 0.07% by mass, and further preferably 0.01 to 0.06% by mass.

The phrase “performing fermentation and maturation at a low temperature of a preparation liquid” in the present disclosure means that the preparation liquid is subjected to the fermentation and maturation at a temperature at which enzymes derived from koji-mold and contained in the preparation liquid are not inactivated (deactivated). Here, the enzymes derived from the koji-mold refer to enzymes produced by the koji-mold, and includes, for example, amylase, protease, lipase and cellulase. These enzymes are weak against heat. In particular, a protease can be inactivated when the fermentation and maturation are performed at 60° C. or more.

According to a preferable embodiment of the present disclosure, fermentation and maturation of a preparation liquid are performed at a low temperature. Here it is desirable that the low temperature is 4° C. to 40° C., preferably 20° C. to 38° C., more preferably 25° C. to 35° C., and further preferably 28° C. to 32° C. The enzymes derived from the koji-mold are not inactivated at these temperatures.

In the present disclosure, the “fermentation and maturation” means not only that fermentation is performed by the koji-mold but also that starch, proteins and lipids contained in rice are decomposed by the enzymes derived from the koji-mold. This may be mainly referred to as saccharification. It is noted that the preparation liquid after performing the fermentation and maturation (i.e., matured product) may be referred to as “salted rice malt (shio-koji, shiokoji, shio koji)”. Therefore, according to an embodiment of the present disclosure, the liquid fermented seasoning is obtained by performing solid-liquid separation of salted rice malt, which is obtained by fermenting and maturing a preparation liquid mixed with rice malt, salt, water, and fermenting microorganisms.

In addition, according to a preferable embodiment of the present disclosure, it is desirable to perform the fermentation and maturation to an extent until the concentration of direct sugar of the preparation liquid after performing the fermentation and maturation (i.e., matured product) is increased by 8% or more relative to the concentration of direct sugar in the first day of the fermentation and maturation, preferably until by 12% or more, and further more preferably until by 18% or more. Here, the direct sugar means direct reducing sugar, and the concentration of direct sugar may vary in accordance with the composition of raw materials of the preparation liquid. According to an embodiment of the present disclosure, it is preferable to perform the fermentation and maturation to an extent until the concentration of direct sugar of the preparation liquid after performing the fermentation and maturation becomes 10% or more, more preferably until 11% or more, further preferably until 12% or more and especially preferably until 13% or more. The concentration of direct sugar can be measured by one of ordinary skill in the art using a known method. For example, the concentration of direct sugar can be measured using Somogyi modification method (Nippon Nogeikagaku Kaishi 28(3) 171-174 (1954)) or a method shown by Japan Agricultural Standards for soy-source.

According to a preferable embodiment of the present disclosure, it is desirable to perform the fermentation and maturation at a low temperature for 1 to 60 days, preferably for 2 to 30 days, further preferably for 3 to 21 days, further more preferably for 4 to 14 days, highly preferably for 6 to 13 days, particularly preferably for 8 to 12 days, and especially preferably for 10 days. As the temperature is lower, the activity of enzymes derived from koji-mold becomes lower and thus the period of the fermentation and maturation becomes longer. Thus, according to a further preferable embodiment of the present disclosure, when the temperature of fermentation and maturation is in the range of 20° C. to 38° C., it is desirable to perform the fermentation and maturation for 3 to 21 days, preferably for 5 to 20 days, further preferably for 8 to 18 days, furthermore preferably for 10 to 16 days, and most preferably for 14 days.

Thus, according to an embodiment of the present disclosure, the liquid fermented seasoning of the present disclosure is obtained by carrying out the solid-liquid separation from the preparation liquid after performing the fermentation and maturation at a low temperature (i.e., matured product) wherein the fermentation and maturation are performed until the concentration of direct sugar respectively become predetermined values, and/or wherein the fermentation and maturation are performed for a predetermined period.

In the present disclosure, the “solid-liquid separation” means a method for separating solid matter from liquid. The solid-liquid separation method is not particularly limited, and may be a method normally used for sweet sake or soy sauce. For example, compression filtration using a compression filtration apparatus, compression using a filter cloth, solid-liquid separation using a centrifugal separation apparatus may be used. The compression filtration is preferable.

The filtrate obtained by the solid-liquid separation can be directly used as the liquid fermented seasoning of the present disclosure.

A product prepared by further diluting the filtrate obtained by carrying out the solid-liquid separation may be used as the liquid fermented seasoning of the present disclosure. Here, it is preferable to perform the dilution so as to obtain a desired salt concentration.

A product prepared by further sterilizing the filtrate obtained by carrying out the solid-liquid separation may be used as the liquid fermented seasoning of the present disclosure. The sterilization method is not particularly limited insofar as the method is used usually for sterilizing liquid. For example, heat sterilization, sterilization by ethanol (spirit) addition, filter sterilization, or the like may be used.

The sterilization by the filter sterilization can be performed, for example, by filtration using diatomaceous earth or by filtration using a microporous membrane. This filtration can reduce or eliminate microorganisms from liquid.

The filtrate obtained by the solid-liquid separation may be further subjected to concentration or decolorization using filtration membrane, resin or the like to obtain the liquid seasoning of the present disclosure.

In addition, the liquid fermented seasoning of the present disclosure may contain other components, such as preservative, antioxidant and spice. Here, in order to avoid inactivation of the enzymes, it is preferable that pH of other components in the aqueous solution is in a neutral range.

According to an embodiment of the present disclosure, a food and drink is provided in which the liquid fermented seasoning is added. It is noted that the liquid fermented seasoning of the present disclosure infiltrates into foods fast. Thus, it is possible in a short time to soften meats, to increase the taste of food and drink, or to impart the good balance among umami, sweetness, and saltiness of the liquid fermented seasoning. Also, since the liquid fermented seasoning has liquid form, it is not necessary to apply or rub to the foods and has a good usability and great convenience. Further, the liquid fermented seasoning of the present disclosure can be used without spoiling the aesthetics of the food because they can maintain transparency.

The food and drink include, for example, other seasonings such as miso, soy sauce, sweet sake, mayonnaise, dressing, and ponzu vinegar; tsuyu such as soup of noodle, soup of oden, and soup of hot pot; tare sauce such as sauce for broiled (grilled, barbecued) meat; soaking solution for meat, fish and vegetable; sauce such as meat sauce, and white sauce; soup; soup stock; confection and bread; and the like.

In addition, the food and drink include cooked foods such as broiled meat and fish in which meat of livestock and fish treated with the seasoning of the present disclosure are used, boiled dish, curry, stew, miso soup, spaghetti, hamburg steak, and dumpling; and processed foods such as kimchi, pickles, kamaboko, sausage, frozen food, ready-made food, and chilled food.

The amount of the liquid fermented seasoning of the present disclosure added to the food and drink, to the meat of livestock, and to the fish is individually and appropriately selected in accordance with the target food and drink.

### EXAMPLES

Although the present disclosure will be described in detail by referring to Examples described below, the present disclosure is not limited to these Examples. Unless otherwise stated, the units and measurement methods described in this application specification shall conform to the methods described in JIS (Japanese Industrial Standards).

### Example 1: Method for Producing Liquid Fermented Seasoning and Evaluation

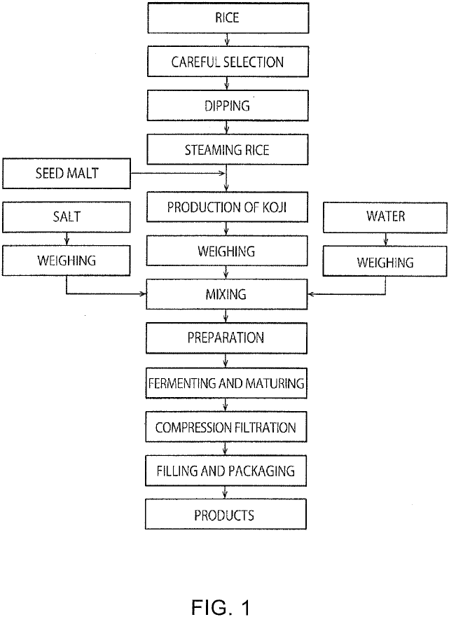

The liquid fermented seasoning was produced in accordance with steps illustrated in FIG. 1.

### Preparation of Malted Rice

Rice was soaked for 12 hours in water having the amount 1.2 times the amount of the rice, and was drained for 2 hours. Then, the drained rice was steamed for 45 minutes using a steamer (produced by Hanyuda Co., Ltd.) and the steamed rice was obtained. After the steamed rice was cooled to the temperature of 30° C., seed malt (seed malt to be used for miso, obtained from Higuchi Matsunosuke Shoten Co., Ltd.) was scattered and mixed several times (tanekiri) so that the seed malt relative to 1 kg of the steamed rice was 0.3 g (steamed rice: seed malt = 1000 : 0.3). While being stirred occasionally, the rice mixed with the seed malt was cultivated for 42 hours at 35° C. by an automatic fermentation machine (HK-60, produced by Yaegaki Food & System, Inc.) and thus malted rice was obtained.

### Preparation of Liquid Fermented Seasoning

A preparation liquid was obtained by mixing 50 kg of malted rice obtained, 8 kg of salt (crude salt), 42 L of water and 20 mL of fermenting microorganisms (Zyqosaccharomyces rouxii). The preparation liquid was subjected to fermentation and maturation for 10 days at 30° C. and a matured product was obtained (Comparison block 1). The matured product obtained was subjected to compression filtration using a compression filtration apparatus (pressure-filtration compression apparatus used for laboratory, produced by NSK Engineering Co., Ltd.), and the filtrate was obtained as a liquid fermented seasoning (test block 1). Liquid fermented seasoning (comparison block 1) was obtained in the same way as in test block 1, except that the fermenting microorganisms were not added to the preparation liquid.

### Evalution of Cloudiness

The liquid fermented seasoning (comparison block 1 or test block 1) was filled into a 500 mL glass container, cooled to the temperature of 4° C., stirred (shaken up and down 10 times) and leaved to stand for 30 days, then mixed the liquid fermented seasoning with vinegar (mass ratio 1:1). The mixture was leaved to stand in a glass beaker for 1 week. The presence or absence of occurrence of cloudiness was visually evaluated by 10 trained panelists. Visually check was performed by a normal person with visual acuity of approximately 1.0 from 30 cm from the side of the beaker.

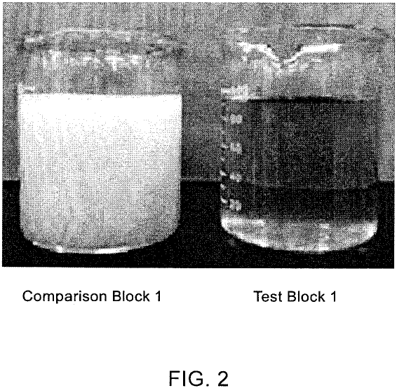

The result was shown in FIG. 2. Cloudiness occurred after the start of test (immediately after the addition of vinegar) in comparison block 1. On the other hands, in test block 1, since no cloudiness was observed at 1 week after the start of the test and the opposite side could be seen through the glass beaker, it was evaluated as transparent. Although it was not shown in the figure, no cloudiness was observed in test block 1 even after one month had elapsed since the start of the test.

### Molecular Weight Distribution Measurement of Liquid Fermented Seasoning

The liquid fermented seasoning of comparison block 1 and test block 1 were filtered through a membrane filter (made of cellulose acetate, 0.45 µm) and subjected to analyze with the following conditions.

### Gel Permeation Chromatography Analyzer

DGU-20A3/ LC-20AD/ CBM-20A SIL-20AHT CTO-20AC/ SPD-M20A RID-10A/ FRC-10A (manufactured by Shimadzu Co., Ltd.)

### Analytical Conditions

Standard material: Gel Filtration Standard (#1511901, peak top molecular weight 1350, 17000, 44000, 158000, 670000 (manufactured by BIO-RAD))
Sample injection volume: 2 µL
Mobile phase: 0.1 M phosphate buffer (pH 6.8)
Flow rate: 0.35 mL/min
Column: BioSep-SEC-s2000 (300 mm x 4.6 mm I.D.)
Column temperature: Room temperature
Detector: Photodiode array detector (wavelength: 280 nm)

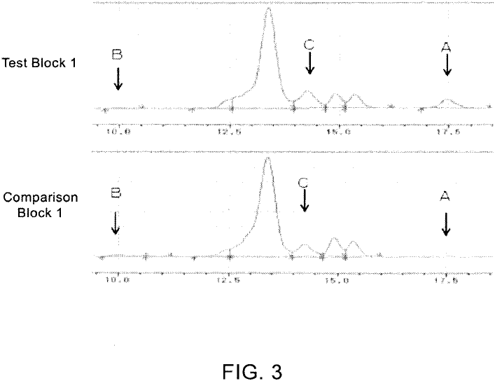

The result was shown in FIG. 3.

In test block 1, peak (A) (retention time is around 17.5 mins) was present in the molecular weight range of 1 to 200 whereas peak (B) was not present in the molecular weight range of 20.000 to 100,000.

On the other hand, in comparison block 1, peak (A) was not present in the molecular weight range of 1 to 200 but peak (B) (retention time is around 10.0 mins) was present in the molecular weight range of 20.000 to 100,000. In addition, peak (C) (retention time is around 14.3 mins) was present in the molecular weight range of 750 to 1300 in both of test block 1 and comparison block 1.

### Example 2: Evaluation of Relationship Between Molecular Weight Distribution and Cloudiness

### Preparation of Liquid Fermented Seasoning

Liquid fermented seasoning of comparison block 2 (content of fermenting microorganisms is 0% by mass), test block 2 (content of fermenting microorganisms is 0.02% by mass) and test block 3 (content of fermenting microorganisms is 0.02% by mass, matured period extended) were prepared by following the process described in Example 1.

### Evaluation of Cloudiness

According to the process described in Example 1, the liquid fermented seasoning of comparison block 2, test block 2 and test block 3 were visually checked for cloudiness after leaved to stand for 2 weeks at room temperature.

Results are shown below.

TABLE 1

| | | | |
|---|---|---|---|
| | Comparison block 2 | Test block 2 | Test block 3 |
| Cloudiness | With cloudiness | Without cloudiness | Without cloudiness |

### Analysis of Molecular Weight Distribution

Molecular weight distribution of the liquid fermented seasoning of comparison block 2, test block 2 and test block 3 were measured and the ratio of peak (A) to peak (C) were analyzed by following the process described in Example 1 (4).

Results are shown below.

TABLE 2

| Peak (A) | Comparison block 2 | Test block 2 | Test block 3 |
|---|---|---|---|
| Area of peak (A) | N. D | 203157 | 406537 |
| Ratio of area of peak (A) to total peak area (peak (A)/total peak area × 100) | N. D | 3.01 | 4.64 |

TABLE 3

| Peak (C) | Comparison block 2 | Test block 2 | Test block 3 |
|---|---|---|---|
| Area of peak (C) | 505085 | 723990 | 897480 |
| Ratio of area of peak (C) to total peak area (peak (C)/total peak area × 100) | 7.08 | 10.72 | 10.25 |

The ratio of peak (A) to peak (C) are shown as below.

TABLE 4

| Peak (A) | Comparison block 2 | Test block 2 | Test block 3 |
|---|---|---|---|
| Ratio of area of peak (A) to area of peak (C) (peak (A)/ peak (C)) | N. D | 0.28 | 0.45 |

### Confirmation Test of Molecular Weight Distribution Analysis

According to the same process as in Example 2, the same test was conducted again for comparison block 3 (content of fermenting microorganisms is 0% by mass), test block 4 (content of fermenting microorganisms is 0.02% by mass), and test block 5 (content of fermenting microorganisms is 0.02% by mass) matured period extended). The same tendency as in (3) was confirmed for the relationship between cloudiness and molecular weight distribution. Cloudiness occurred in comparative block 3 and did not occur in test block 4 and test block 5.

However, in comparison block 3, the presence of a very small peak (A) was observed. The ratio of area of peak (A) to total peak area (peak (A)/total peak area × 100) was 1.42. The ratio of area of peak (A) to area of peak (C) (peak (A)/peak (C)) was 0.21.

According to the result of Example 2 and 3, it was confirmed that cloudiness does not occur when the ratio of the area of peak (A) to the total peak area is 2.0 or more, or when the ratio of the area of peak (A) to the area of peak (C) ratio (Peak (A)/Peak (C)) is 0.24 or more. This result was also confirmed by conducting the same test as in Example 1 with 7 liquid fermented seasoning samples with different peak area ratios.

### Example 3: Comparison of Ingredients of Liquid Fermented Seasoning

Ingredient comparison of comparison block 1, test block 1, commercially available soy sauce (honjozo soy sauce, made by Kikkoman Co., Ltd.), sweet sake (hon mirin, made by Manjoh Co., Ltd.) and cooking sake (junmai cooking sake, made by Mitsukan Co., Ltd.) were conducted according to the procedure described below.

### pH

The pH measurement was performed using a pH meter (F-72, produced by Horiba Co., Ltd.).

### Direct Sugar

The direct sugar measurement was performed by Somogyi modification (Nippon Nogeikagaku Kaishi 28 (3) 171-174 (1954)).

### Salt

The salt measurement was performed using a potential-difference titration device (AT- 500N, produced by Kyoto Electronics Manufacturing Co., Ltd.).

### Protease Enzyme Activity

The enzyme activity measurement was performed in terms of the protease activity at pH 6.0, which was measured by Kageyama modification of phenol reagent method of Folin-Ciocalteu (Hakkokogaku Zasshi 33 (1) 28-32 (1955)). Specifically, the following method was used. Each of 5 g samples (matured product, liquid fermented seasoning) was subjected to 10 folds dilution using 0.5% NaCl solution and filtration. Then, 1 mL of the filtrate (sample solution) was further diluted using 4 mL of phosphate buffer at pH 6.0. A 2-mL aliquot of a solution prepared by adding phosphate buffer at pH 6.0 to milk casein to make a concentration of 1.5% was added as a substrate to 1 mL of the diluted solution obtained (test liquid), and the resultant mixture was reacted for 1 hour at 37° C. Then, 4 mL of 0.4 mol/L trichloroacetic acid was added to stop the reaction. The solution obtained was filtered. To 1 mL of the filtrate, 5 mL of 0.4 mol/L sodium carbonate was added, and 1 mL of a phenol reagent was further added. Then, the resultant mixture was allowed to develop color for 20 minutes at 37° C. The colored solution was used as a test sample. Note that a control (blank sample) was prepared in the following way. First, 4 mL of 0.4 mol/L trichloroacetic acid was added to 2 mL of the substrate in advance, 1 mL of the test liquid was added thereto, and the resultant mixture was reacted for 1 hour at 37° C. Then, the reaction mixture was filtered and the firtrate was used for color development. The absorbance of the test sample and the blank sample at the wavelength of 660 nm was measured using a spectrophotometer (UV-1200, Shimadzu Co., Ltd.). The absorbance of the blank sample was subtracted from the absorbance of the test sample, and the result was multiplied by the dilution ratio and the factor (coefficient) of the phenol reagent to obtain the protease activity (unit/g) for 1 g of the sample (specifically, protease activity (unit/g) = [absorbance of the test sample - absorbance of the blank sample] × 350 (the dilution ratio) x factor of the phenol reagent). Here, the factor of the phenol reagent was calculated using a tyrosine solution. Specifically, the absorbance was measured under the same conditions as above except that 1 mL of 50 µg/mL tyrosine solution was used instead of the above-described solution. The factor of the phenol reagent was obtained by dividing the standard absorbance of the tyrosine solution of 0.350 by the measured absorbance. (Specifically, the factor of phenol reagent = 0.350/absorbance of 50 µg/mL tyrosine solution for each preparation of the phenol reagent).

### Sensory Evaluation

The sensory evaluation was carried out by 10 trained, specialized panelists. Items of “odor” and “taste” of the liquid fermented seasonings (test block 1 and comparison block 1) were evaluated as described below and the average values are shown. In addition, sensory findings are also shown.

### Sensory Evaluation Criteria

The “odor” was evaluated using the following evaluation criteria.

5: Good. No offensive smell (koji-specific smell (that is, koji smell), smell produced by heating, stuffy smell) is felt. Sweet smell is strongly felt.

4: Slightly good. No offensive smell is felt. Sweet smell is felt.

3: Normal. No offensive smell is felt.

2: Slightly bad. A little offensive smell is felt.

1: Bad. Offensive smell is felt.

The “taste” was evaluated using the following evaluation criteria.

5: Good. No foreign taste (unpleasant taste) is felt. The balance among umami, sweetness and saltiness is very good.

4: Slightly good. No foreign taste is felt. The balance among umami, sweetness and saltiness is slightly good.

3: Normal. No foreign taste is felt. The balance among umami, sweetness and saltiness is good.

2: Slightly bad. A little foreign taste is felt. A little bitter taste is felt in umami, sweetness and saltiness.

1: Bad. Foreign taste is felt. Bitter taste is felt in umami, sweetness and saltiness.

TABLE 5

| | Comparison block 1 | Test block 1 | Soy sauce | Sweet sake | Cooking sake |
|---|---|---|---|---|---|
| Raw materials | Malted rice and salt | Malted rice, slat and fermenting microorganism | Soy bean, wheal, salt and alcohol | Rice, malted rice, brewing alcohol and sugar | Rice, salted rice malt, salt and brewing alcohol |
| pH | 5.14 | 4.48 | 4.47 | 5.05 | 4.63 |
| Salt | 12.0 | 12.0 | 14.4 | N. D | 2.2 |
| Direct sugar | 24.1 | 14.4 | 2.6 | 33.6 | 1.0 |
| Protease Enzyme activity (unit/g) | 40.0 | 24.3 | N. D | N. D | N. D |
| Ratio of area of total peak to area of peak (A) (peak (A)/area of total peak × 100) | N. D | 3.01 | 11.7 | N. D | N. D |
| Ratio of area of total peak to area of peak (C) (peak (C)/area of total peak × 100) | N. D | 0.28 | - | N. D | N. D |
| Turbidity | transparent | transparent | opaque (black) | transparent | transparent |
| Smell | 3.2 | 5.0 | 4.5 | 2.8 | 2.5 |
| Taste | 3.0 | 5.0 | 4.2 | 2.5 | 2.2 |
| Sensory findings | ▪Gold-colored Liquid. ▪Strong sweetness | ▪Gold-colored Liquid. ▪Malt smell is less than Comparison block 2 ▪Weak sweetness, strong umami ▪Sweetness, saltiness and umami is well-balanced | ▪There is a sharp taste of salt | ▪Too sweet | ▪Bad balance |

Note that almost the same result as test block 1 was obtained when the same test as in Example 3 was conducted to 7 samples (rice-derived liquid fermented seasonings) that meet the following criteria: salt 2 to 20 mass%, direct sugar 10 mass% or more, portase 10 to 30 units/g and peak (A)/total peak area ×100 is 2.0 or more.

1. A rice-derived liquid fermented seasoning wherein in a chromatogram curve obtained by high-performance liquid chromatography (HPLC) measurement using a gel filtration carrier under the following analysis conditions, the ratio of the area of peak (A) detected at a retention time of around 17.5 minutes to the total peak area (area of peak (A)/total peak area × 100) in the chromatogram curve is 2 or more.
[HPLC analysis condition]
Mobile phase: 0.1 M phosphate buffer (pH 6.8)
Flow rate: 0.35 mL/min
Gel filtration column: Silica packed column (column length 300 mm × inner diameter 4.6 mm)
Detection wavelength: 280 nm.

2. The liquid fermented seasoning according to claim 1, wherein the chromatogram curve is a chromatogram curve in the range of molecular weight 0 to 670,000.

3. The liquid fermented seasoning according to claim 1, wherein the molecular weight of the peak (A) is in the range of 0 to 200.

4. The liquid fermented seasoning according to claim 1, wherein the ratio of the area of peak (C) detected at a retention time around 14.3 minutes to the total peak area (area of peak (C)/total peak area × 100) is 7.5 or more.

5. The liquid fermented seasoning according to claim 4, wherein the peak (C) molecular weight is in the range of 750 to 1,300.

6. The liquid fermented seasoning according to claim 1, wherein the ratio of the area of peak (A) to the area of peak (C) (area of peak (A)/area of peak (C)) is 0.24 or more.

7. The liquid fermented seasoning according to claim 1, having protease activity.

8. The liquid fermented seasoning according to claim 1, wherein the protease activity at pH 6.0 is 5 units/g or more.

9. The liquid fermented seasoning according to claim 1, wherein the salt content is 2 to 20% by mass.

10. The liquid fermented seasoning according to claim 1, wherein the water content is 30 to 70% by mass.

11. The liquid fermented seasoning according to claim 1, wherein the content of direct reducing sugar is 10% by mass or more.

12. The liquid fermented seasoning according to claim 1, wherein the fermented raw material of the liquid fermented seasoning includes at least one ingredient selected from the group consisting of rice, malted rice and salted rice malt.

13. A food or drink prepared by adding the liquid fermented seasoning according to claim 1.

14. A method for producing a liquid fermented seasoning according to claim 1, comprising:
obtaining a fermented and matured product by fermenting and maturing a preparation liquid in which rice malt, salt, water, and fermenting microorganisms are mixed;
performing solid-liquid separation of the fermented and matured product.

15. The method for producing liquid fermented seasonings according to claim 14, wherein the fermenting microorganism is at least one selected from the group consisting of yeast, koji mold, and lactic acid bacteria.
